(19) United States
(12) Patent Application Publication
(10) Pub. No.: US 2006/0267315 A1
(43) Pub. Date: Nov. 30, 2006

(54) Bracket assembly for an inflatable curtain

(75) Inventor: Michael J. White JR., Dryden, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/138,608

(22) Filed: May 26, 2005

(51) Int. Cl. B60R 21/22

(52) U.S. Cl. 280/730.2; 280/728.2

(57) ABSTRACT

An apparatus (10) for supporting an inflatable curtain (14) and a fill tube (22) in a vehicle (12) includes a bracket (130) including a support portion (152) for receiving a portion of the fill tube. The apparatus (10) also includes a retainer (200) connectable to the bracket (130) to retain the fill tube (22) in the support portion (152). The retainer (200) and the bracket (130) have cooperating portions (214, 186) that interlock with each other to help connect the retainer to the bracket. The bracket (130) includes at least one tab (188) extendable through the retainer (200) and deformable against the retainer to help connect the retainer to the bracket. The retainer (200) and the support portion (152) in combination encircle the portion of the fill tube (22) to connect the fill tube to the bracket (130).

### FIELD OF THE INVENTION

The present invention relates to an apparatus for helping to protect an occupant of a vehicle in the event of a side impact to the vehicle, a vehicle rollover, or both. In particular, the present invention relates to a bracket assembly for helping to connect the apparatus to the vehicle.

### BACKGROUND OF THE INVENTION

It is known to inflate an inflatable vehicle occupant protection device to help protect a vehicle occupant. One particular type of inflatable vehicle occupant protection device is an inflatable curtain. The inflatable curtain is inflatable away from the roof of the vehicle between a vehicle occupant and the side structure of the vehicle in response to a side impact to the vehicle and/or a vehicle rollover. A known inflatable curtain is inflated from a deflated condition with inflation fluid directed from an inflator to the inflatable curtain via a fill tube.

### SUMMARY OF THE INVENTION

The present invention relates to An apparatus for supporting an inflatable curtain and a fill tube in a vehicle includes a bracket including a support portion for receiving a portion of the fill tube. The apparatus also includes a retainer connectable to the bracket to retain the fill tube in the support portion. The retainer and the bracket have cooperating portions that interlock with each other to help connect the retainer to the bracket. The bracket includes at least one tab extendable through the retainer and deformable against the retainer to help connect the retainer to the bracket. The retainer and the support portion in combination encircle the portion of the fill tube to connect the fill tube to the bracket.

The present invention also relates to an apparatus for supporting an inflatable curtain and a fill tube in a vehicle. The apparatus includes a bracket including a support portion for receiving a portion of the fill tube and a retainer connectable to the bracket to retain the fill tube in the support portion. The retainer includes a hook portion for hooking onto the support portion to help connect the retainer to the bracket. The bracket includes at least one tab extendable through openings in the retainer and deformable against the retainer to help connect the retainer to the bracket. The retainer and the support portion connect the fill tube to the bracket.

The present invention also relates to an apparatus for helping to protect an occupant of a vehicle that has a roof and a side structure. The apparatus includes an inflatable curtain that is inflatable away from the vehicle roof to a position adjacent the side structure of the vehicle. A fill tube directs inflation fluid from an inflation fluid source into the inflatable curtain. A bracket includes a support portion for receiving a portion of the fill tube. A retainer is connectable to the bracket to retain the fill tube in the support portion. The retainer has a portion that interlocks with the support portion to help connect the retainer to the bracket. The bracket includes at least one tab extendable through the retainer and deformable against the retainer to help connect the retainer to the bracket. The retainer and the support portion in combination encircling the portion of the fill tube to connect the fill tube to the bracket.

The present invention further relates to a bracket assembly for supporting an inflatable curtain and a fill tube in a vehicle. The bracket assembly includes a support portion for receiving a portion of the fill tube and connecting the fill tube to the bracket assembly. The bracket assembly also includes a connecting portion for receiving fastening means for connecting the bracket assembly fixedly to the vehicle. The bracket assembly further includes a hook portion insertable into an opening in the vehicle to initially support the bracket assembly, the fill tube, and the inflatable curtain in the vehicle. The hook portion includes a barb portion for engaging vehicle sheet metal adjacent the opening into which the hook portion is insertable to help prevent removal of the hook portion from the opening.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of an apparatus for helping to protect a vehicle occupant illustrating the apparatus in a deflated and stored condition in a vehicle, according to a first embodiment of the present invention;

FIG. 2 is a schematic view of the apparatus of FIG. 1 in an inflated condition in the vehicle;

FIG. 3 is a sectional view taken generally along line 3-3 in FIG. 2;

FIG. 4 is a sectional view taken generally along line 4-4 in FIG. 1;

FIG. 5 is a sectional view taken generally along line 5-5 in FIG. 2;

FIGS. 6 and 7 are perspective views of portions of the apparatus of FIGS. 1-5;

FIG. 8 is a perspective view illustrating the assembly of the portions of the apparatus illustrated in FIGS. 6 and 7; and

FIG. 9 is a magnified sectional view of a portion of the apparatus in an installed condition.

### DESCRIPTION OF AN EMBODIMENT

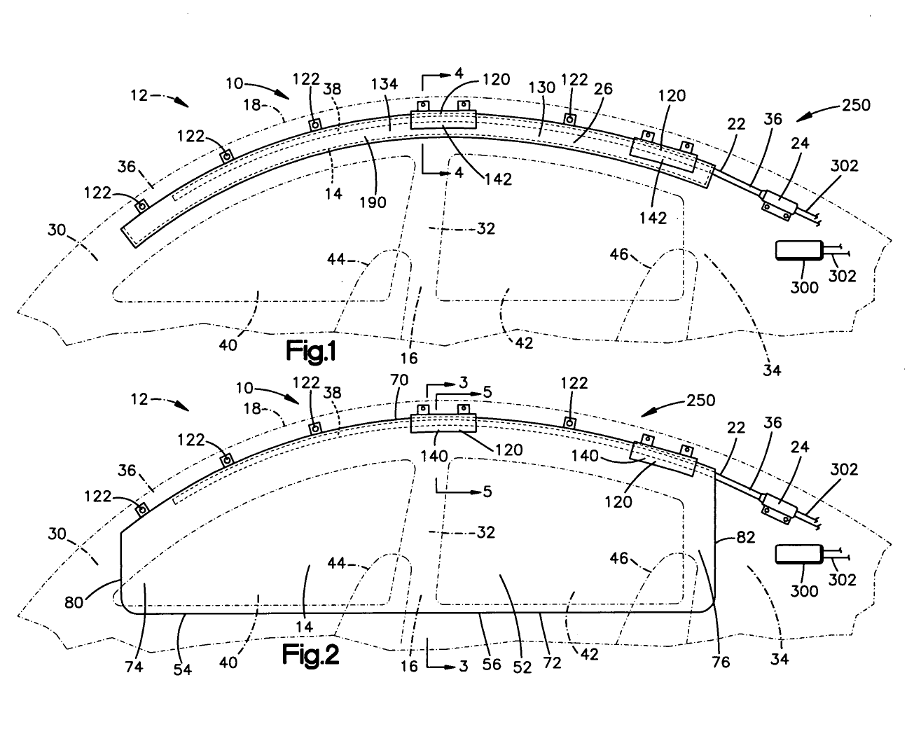

Representative of the present invention, an apparatus 10 helps to protect an occupant of a vehicle 12. As shown in FIGS. 1 and 2, the apparatus 10 includes an inflatable vehicle occupant protection device in the form of an inflatable curtain 14 that is mounted adjacent the side structure 16 of the vehicle 12 and the roof 18 of the vehicle. The side structure 16 of the vehicle 12 includes an A pillar 30, a B pillar 32, a C pillar 34, and front and rear side windows 40 and 42. The vehicle 12 also includes front vehicle seating 44 positioned adjacent the front side window 40 and rear vehicle seating 46 positioned adjacent the rear side window 42.

An inflator 24 is connected in fluid communication with the inflatable curtain 14 through a fill tube 22. The fill tube 22 may be constructed of any suitable material, such as metal or plastic. The fill tube 22 has a first end portion 36 for receiving fluid from the inflator 24. The fill tube 22 may be connected directly to the inflator 24 or a manifold (not shown) may connect the fill tube to the inflator. The fill tube 22 has a second end portion 38 disposed in the inflatable curtain 14.

The inflator 24 contains a stored quantity of pressurized inflation fluid (not shown) in the form of a gas for inflating the inflatable curtain 14. The inflator 24 alternatively could contain a combination of pressurized inflation fluid and ignitable material for heating the inflation fluid, or could be a pyrotechnic inflator that uses the combustion of gas-generating material to generate inflation fluid. As a further alternative, the inflator 24 could be of any suitable type or construction for supplying a medium for inflating the inflatable curtain 14.

The apparatus 10 may include a cover 26 (FIG. 1), such as a fabric sheath or plastic housing, that helps support the inflatable curtain 14 in a stored and deflated condition. The deflated inflatable curtain 14 and the cover 26 have an elongated configuration and extend along the vehicle roof 18 and along the side structure 16 of the vehicle 12 above the side windows 40 and 42. The fill tube 22, inflatable curtain 14 and cover 26 are connected to the vehicle 12 by bracket assemblies 120 (illustrated schematically in FIGS. 1 and 2). The inflatable curtain 14 may also include tabs 122 through which means, such as fasteners, may extend to help connect the curtain to the vehicle 12.

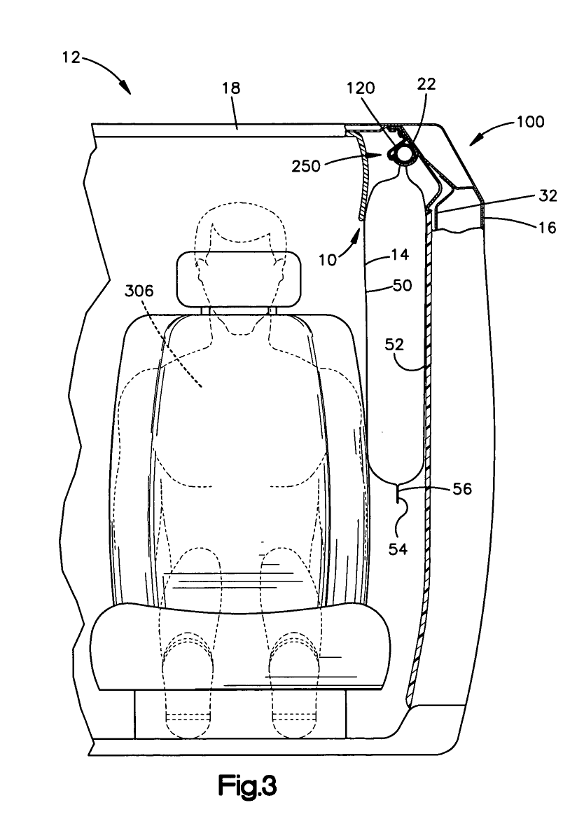

The inflatable curtain 14 (FIG. 3) includes panels 50 and 52 of material that are arranged in an overlying manner. Overlapping portions of the panels 50 and 52 are interconnected along at least a portion of a perimeter 54 (FIGS. 2 and 3) of the inflatable curtain 14 to form a perimeter connection 56 of the curtain. The perimeter connection 56 helps define an inflatable volume of the inflatable curtain 14. The inflatable curtain 14 may also include interior connections (not shown) in which the overlying panels 50 and 52 are interconnected within the perimeter 54 to form non-inflatable portions that help define inflatable chambers of the curtain.

The inflatable curtain 14 may be formed in a variety of manners, such as by interweaving the overlying panels 50 and 52, stitching the panels together, or interconnecting the panels via ultrasonic welding, heat bonding, or adhesives. In a woven construction, the overlying panels 50 and 52 may be woven/interwoven simultaneously from a material, such as nylon yarn, and may be coated with a gas impermeable material, such as urethane, or laminated with a gas impermeable film. The inflatable curtain 14 thus may have a substantially gas-tight construction. Those skilled in the art will appreciate that alternative materials, such as polyester yarn, and alternatives coatings, such as silicone, may also be used to construct the inflatable curtain 14.

The perimeter 54 of the inflatable curtain 14 is defined at least partially by an upper edge 70, an opposite lower edge 72 of the curtain, and front and rear portions 74 and 76, respectively, of the inflatable curtain spaced apart horizontally along the upper and lower edges. The front and rear portions 74 and 76 of the inflatable curtain 14 include front and rear edges 80 and 82, respectively, that are spaced horizontally apart along the upper and lower edges 70 and 72 and extend between the upper and lower edges.

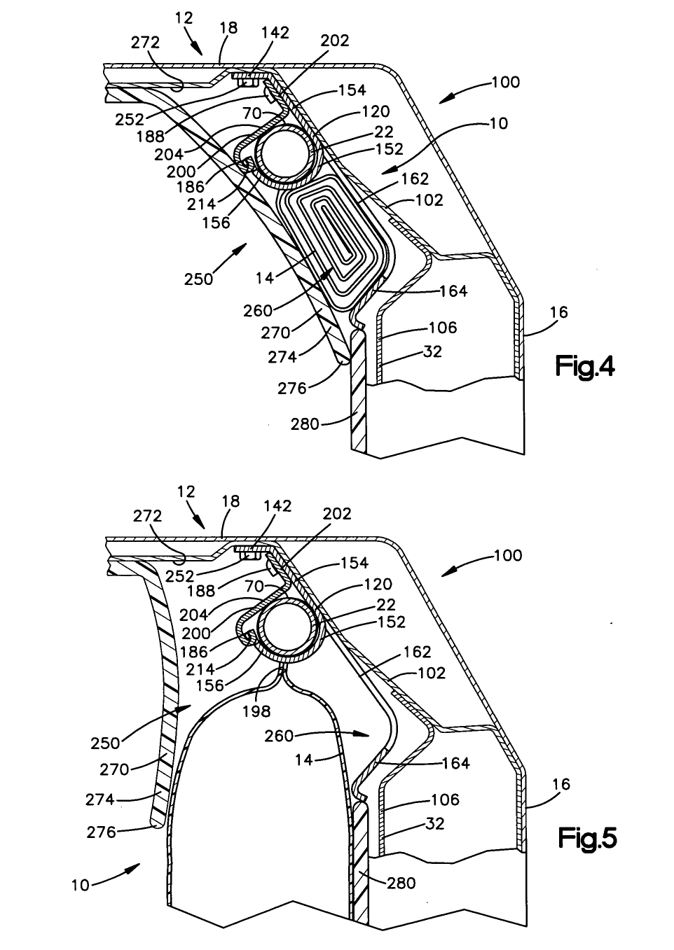

As illustrated in FIGS. 3-5, a vehicle roof rail 100 is located at the intersection of the side structure 16 of the vehicle and the vehicle roof 18. The side structure 16, roof 18 and roof rail 100 are formed from pieces of sheet metal that are stamped or otherwise formed into predetermined shapes and welded or otherwise connected to form a desired structure. As best shown in FIGS. 4 and 5, inner and outer pieces of sheet metal 102 and 104, respectively, are used to form the side structure 16, roof 18 and roof rail 100. A third piece of sheet metal 106 helps to form the B pillar 32 of the vehicle 12. Those skilled in the art will, however, appreciate that the side structure 16, roof 18, roof rail 100, and B pillar 32 may have alternative constructions.

The bracket assemblies 120 are preferably constructed of a high-strength material, such as metal, that may be formed through a variety of metalworking operations, such as stamping, hydroforming, bending, and machining. Alternative materials, such as plastics or composites, and alternative constructions, could also be used to form the brackets 120.

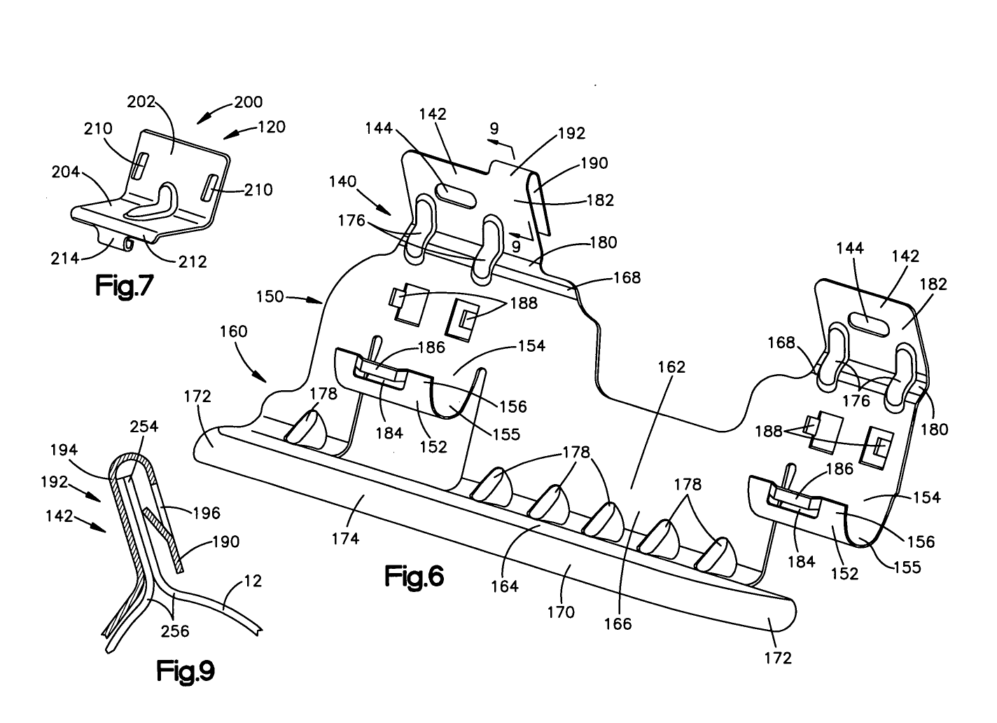

Referring to FIGS. 6-8, each bracket assembly 120 includes a support bracket 130 and a pair of retainers 200. The support bracket 130 includes a connecting portion 140, a fill tube support portion 150, and a deployment portion 160. The deployment portion 160 spans the length of the support bracket 130. The deployment portion 160 includes a generally planar main portion 162 and a ramp portion 164. The ramp portion 164 curves away from a lower end portion 166 of the main portion 162 and extends transverse to the main portion. For example, in the illustrated embodiment, the ramp portion 164 may extend at an angle of about 105 degrees relative to the main portion 162.

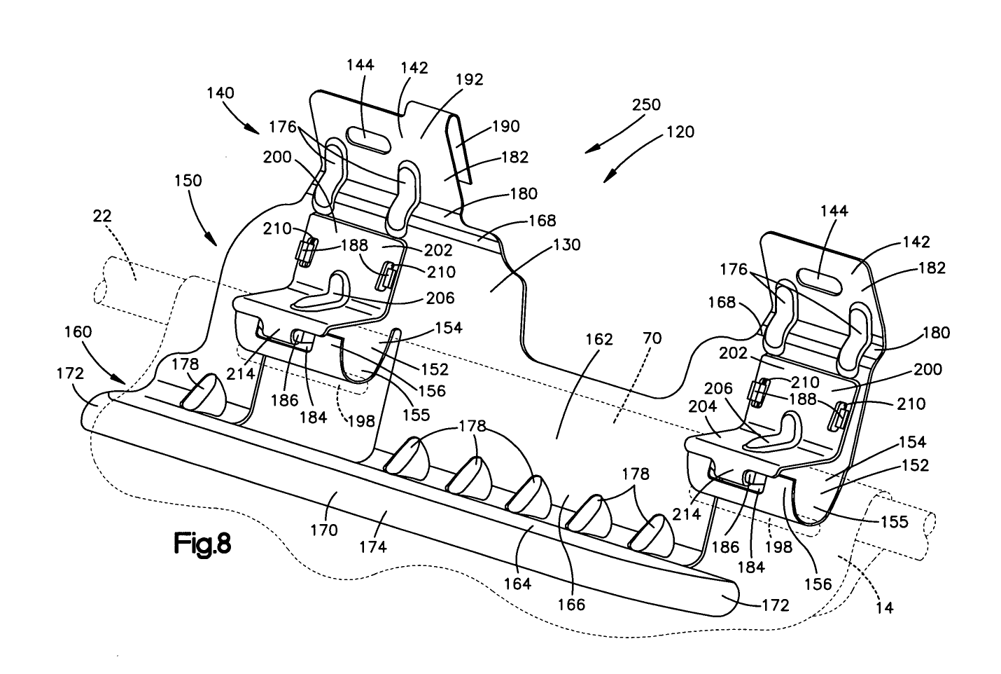

The fill tube support portion 150 includes a pair of spaced generally C-shaped supports 152 that extend transversely from the main portion 162, above the lower end portion 166 as viewed in FIGS. 6 and 8. The fill tube support portion 150 may include one or more such supports 152. Each of the supports 152 has a first end portion 154 that merges with the main portion 162 and extends away from the main portion in the same general direction that the ramp portion 164 extends from the main portion. Each of the supports 152 also has a second end portion 156, opposite the first end portion 154, and a central or middle portion 155 that has a generally curved or C-shaped configuration. The second end portion 156 includes a slot or opening 184 that helps define a hook bar portion 186 of the support 152. As shown in FIG. 6, the hook bar portion 186 may project away from an outer surface of the support 152.

The fill tube support portion 150 also includes a pair of tabs 188 spaced above each support portion 152, as viewed in FIG. 6. The tabs 188 project away from a surface of the support portion 150 in the same general direction that the supports 152 project from the support portion 150.

The connecting portion 140 includes a pair of spaced flange portions 142, each of which include an opening 144 that extends through the flange. The connecting portion 140 may include one or more such flange portions 142. Each flange portion 142 has a first portion 180 that extends transversely from an upper end portion 168 of the main portion 162 and a second portion 182 that extends transversely from the first portion. Each flange portion 142 may also include a hook portion 190. In the illustrated embodiment, one of the flange portions 142, indicated at 192, includes a hook portion 190. As shown in FIG. 9, the hook portion 190 extends generally downward from an upper end portion 194 of the flange portion 192 and includes barb 196 that protrudes from the hook portion and extends toward the flange portion 142.

As shown in FIGS. 6 and 8, the deployment portion 160 has a rounded over end portion 170 that extends along opposite lateral edges 172 of the ramp portion 164, and along a forward edge 174 of the ramp portion. The connecting portions 140 and the deployment portion 160 may also include reinforcing portions for improving their structural integrity. In the illustrated embodiment, the flange portions 142 may include reinforcing ribs 176 spaced along the connecting portion 140 that extend from the upper edge portion 168 of the main portion 162 to the first and second portions 180 and 182 of the flange portions 142. The deployment portion 160 may include reinforcing ribs 178 that extend from the main portion 162 to the ramp portion 164. The reinforcing ribs 176 and 178 may help improve the structural integrity of the connecting portion 140 and deployment portion 160 and also may help prevent them from bending or being otherwise deformed from the condition illustrated in FIGS. 6 and 8.

Referring to FIGS. 7 and 8, each retainer 200 includes a connector portion 202 and a retainer portion 204 that extend transverse to each other. A reinforcing rib 206 may extend from the connector portion 202 to the retainer portion 204 to help improve the structural integrity of the retainer 200. The connector portion 202 includes a pair of tab receiving openings 210 positioned along opposite edges of the connector portion. The retainer portion 204 has a curved terminal end portion 212 that includes a central hook portion 214. As viewed in FIG. 7, the hook portion 214 has a generally curved configuration, extending downward from the end portion 212 and curving back upwards toward a lower surface of the retainer portion 204.

Referring to FIGS. 4, 5, and 8, the inflatable curtain 14 may have openings 198 positioned adjacent portions of the fill tube 22. In an assembled condition of the apparatus 10, the fill tube 22 is positioned in the inflatable curtain extending along the upper edge 70 of the curtain. The bracket assemblies 120 are positioned to extend through the openings 198 in the inflatable curtain 14 such that the fill tube 22 and inflatable curtain 14 are received in the supports 152. As best shown in FIGS. 4 and 5, the cylindrical configuration of the fill tube 22 may mate with a cylindrical inner surface of the middle portion 155 of the supports 152.

With the fill tube 22 and inflatable curtain 14 received in the supports 152, the retainers 200 are installed. The hook portion 214 of each retainer 200 is maneuvered to extend through the opening 184 and hook onto the hook bar portion 186 of its respective support 152. For each support 152, the associated hook portion 214 curves around the hook bar portion 186 and extends into the slot 184. The hook portion 214 hooks onto the hook bar portion 186 and secures the retainer portion 204 to the second end portion 156 of the associated support 152.

With the hook portions 214 hooked onto their respective hook bar portions 186, the retainer portions 204 are positioned to extend from the second end portion 156 to the first end portion 154 of the respective support portions 152. In this position, the retainer portions 204 overlie the portions of the inflatable curtain 14 and fill tube 22 received in the support portions 152. Also, in this position, the connector portions 202 extend along and overlie the support portion 150 such that the tabs 188 extend through the tab receiving openings 210 in the connector portion 202 of the retainer 200. With the apparatus 10 in this condition, the tabs 188 are bent over or otherwise deformed against the retainers 200 to lock the retainers onto the supports 152, thus connecting the retainers to the support bracket 130. This is best shown in FIGS. 4, 5, and 8. With the retainers 200 locked onto the supports 152, the inflatable curtain 14 and fill tube 22 are secured in the bracket assembly 120. No separate fastening means, such as threaded fasteners or rivets, are required to connect the retainers 200 to the support bracket 130.

In the assembled condition, the inflatable curtain 14, fill tube 22, and bracket assemblies 120 may form a module 250 that may be installed in the vehicle 12 as a unit. The module 250 may also include the inflator 24 and the cover or housing 26. As shown in FIGS. 4 and 5, the module 250 is positioned adjacent the roof rail 100 near the intersection of the side structure 16 and roof 18.

The hook portions 190 of the bracket assemblies 120 may be used initially to support the module 250 in the vehicle 12 while fasteners 252 are installed to connect the module fixedly to the vehicle. The hook portions 190 may be installed on respective flange portions 254 (see FIG. 9) of the structure of the vehicle 12 (e.g., the side structure 16 or roof rail 100) to support the module 250 on the sheet metal 256 that forms the vehicle structure. The barb 196 on each hook portion 190 permits the hook portion 190 to slide onto the vehicle sheet metal 256, and may help grab onto the sheet metal to help prevent the hook portion from becoming dislodged from the flange portion 254. This helps prevent the module 250 from being disconnected from the vehicle 12 during installation.

With the module 250 supported on the vehicle 12 by the hook portions 190, the fasteners 252, e.g., bolts, are passed through the openings 144 in the flange portions 142 and screwed into the roof rail 100 to secure the connecting portion 140, and thus the assembly 250, fixedly to the vehicle 12. It will be appreciated that the hook portions 190 may be omitted, in which alternative means, such as manually positioning the module 250 in the vehicle 12, may be required.

When the module 250 is installed in the vehicle 12, the main portion 162 of the deployment portion 160 extends along the side structure 16 of the vehicle 12 in a direction generally downward and away from the vehicle roof 18, as viewed in FIGS. 4 and 5. The ramp portion 164 extends transverse to the main portion 162 in a direction generally away from the vehicle side structure 16, diagonally downward and inboard of the vehicle side structure, as viewed in FIGS. 4 and 5.

The deployment portion 160 forms a generally concave channel 260 for receiving the inflatable curtain 14 in a stored condition. The inflatable curtain 14 can be placed in the stored condition by rolling the curtain in an outboard direction, as shown in FIG. 4, or by rolling the curtain in an opposite inboard direction (not shown). Alternatively, the inflatable curtain 14 can be placed in the stored condition by folding the curtain or by a combination of rolling and folding the curtain.

The module 250, when in the installed condition of FIGS. 1 and 4, extends along the roof rail 100 and along the intersection of the side structure 16 and the roof 18. The vehicle 12 includes a headliner 270 that extends along an inner surface 272 of the roof 18 of the vehicle. The headliner 270 has a portion 274 that extends at an acute angle relative to the roof 18 adjacent the module 250. The portion 274 of the headliner 270 overlies the module 250 and conceals the module in the vehicle 12. A terminal end 276 of the headliner 270 is in abutting engagement with a trim piece 280 of the vehicle 12.

Those skilled in the art will recognize that the configuration of the vehicle structure and, thus, the spatial and interconnecting relationships between the vehicle structure (i.e., the side structure 16, roof 18, and roof rail 100) and the headliner 270, trim piece 280 and module 250 may vary depending upon the particular design of the vehicle 12. Therefore, it should be recognized that the vehicle structure illustrated in FIGS. 4 and 5 and the spatial and interconnecting relationships between the vehicle structure and the headliner 270, trim piece 280 and module 250 is for illustrative purposes and may vary without departing from the spirit of the present invention.

As shown in FIG. 4, the trim piece 280 overlies the B pillar 32 of the vehicle 12 and is positioned generally adjacent and below the module 250. Similar trim pieces (not shown) may also overlie the C pillar 34 (FIGS. 1 and 2) of the vehicle 12. The configuration of the vehicle structure and the spatial and interconnecting relationships between the vehicle structure and the headliner 270, trim piece 280 and module 250 at these locations would be similar to that illustrated in FIGS. 4 and 5. Therefore, FIGS. 4 and 5 may be illustrative of the module 250 and the vehicle 12 at the B pillar 32 and C pillar 34 of the vehicle 12.

The vehicle 12 includes a sensor mechanism 300 (shown schematically in FIGS. 1 and 2) for sensing the occurrence of an event for which inflation of the inflatable curtain 14 is desired, such as a side impact to the vehicle 12, a vehicle rollover, or both. Upon sensing the occurrence of such an event, the sensor mechanism 300 provides an electrical signal over lead wires 302 to the inflator 24. The electrical signal causes the inflator 24 to be actuated in a known manner. The inflator 24 discharges fluid under pressure through fill tube 22, which directs the fluid into the inflatable curtain 14.

The inflatable curtain 14 inflates under the pressure of the inflation fluid from the inflator 24. This causes the cover 26 to open, for example, along a tear seam (not shown), which permits the curtain to inflate away from the roof 18 in a downward direction as shown in the drawings and in a downward direction with respect to the direction of forward travel of the vehicle 12 into the position illustrated in FIG. 2.

The inflatable curtain 14, when inflated, extends along the side structure 16 of the vehicle 12 and is positioned between the side structure and any occupant of the vehicle. The inflatable curtain 14 covers portions of the vehicle side structure that extend between the A pillar 30 and the C pillar 34 of the vehicle 12 and may overlie portions of the A pillar, C pillar, and the B pillar 32 of the vehicle. The inflatable curtain 14, when inflated, may be positioned between the vehicle side structure 16 and the front and rear vehicle seating 44 and 46, as well as any occupant 306 (see FIG. 3) of the seating.

Those skilled in the art will appreciate that the extent and coverage of the inflatable curtain 14 in the vehicle 12 may vary. For example, the extent and coverage of the inflatable curtain 14 may vary depending on a variety of factors, such as the architecture of the vehicle 12, the position of the inflatable curtain 14 in the vehicle, and the desired extent or coverage of the inflatable curtain.

The inflatable curtain 14, when inflated, helps to protect a vehicle occupant in the event of a vehicle rollover or a side impact to the vehicle 12. The inflatable curtain 14 may cover an area of the side structure 16 extending from the A pillar 30 to the C pillar 34 and from the roof 18 down to adjacent or below the side windows 40 and 42. The inflatable curtain 14, when inflated, helps to absorb the energy of impacts with the curtain and helps to distribute the impact energy over a large area of the curtain.

Referring to FIGS. 3-5, as a feature of the present invention, the deployment portion 160 helps to deflect or otherwise direct the inflatable curtain 14 to inflate inboard of the trim piece 280, between the trim piece and any occupant of the vehicle 12. During inflation of the inflatable curtain 14, the ramp portion 164 of the deployment portion 160 helps prevent the curtain from getting caught on the trim piece 280 or inflating between the trim piece and the side structure 16. The ramp portion 164 directs the inflatable curtain 14 to deploy in an inboard direction (i.e., to the left as viewed in FIGS. 3-5) around the trim piece 220.

As shown in FIGS. 1 and 2, the bracket assemblies 120 are positioned along the side structure 16 to coincide with the B pillar 32 and C pillar 34 of the vehicle 12. This places ramp portions 164 adjacent respective trim pieces on the B pillar 32 and C pillar 34 and thus helps direct the inflatable curtain 14 to inflate inboard of the trim pieces 280 at each of the pillars.

From the above description of the invention, those skilled in the art will perceive improvements, changes and modifications. Such improvements, changes and modifications within the skill of the art are intended to be covered by the appended claims.

Having described the invention, the following is claimed:

1. An apparatus for supporting an inflatable curtain and a fill tube in a vehicle, said apparatus comprising:
a bracket including a support portion for receiving a portion of the fill tube; and
a retainer connectable to said bracket to retain the fill tube in said support portion, said retainer and said bracket having cooperating portions that interlock with each other to help connect said retainer to said bracket;
said bracket including at least one tab extendable through said retainer and deformable against said retainer to help connect said retainer to said bracket, said retainer and said support portion in combination encircling the portion of the fill tube to connect the fill tube to said bracket.

2. The apparatus recited in claim 1, wherein said bracket further comprises a deployment portion for helping to direct the inflatable curtain to inflate and deploy inboard of a trim piece that overlies a portion of a side structure of the vehicle.

3. The apparatus recited in claim 2, wherein said deployment portion extends away from the side structure when the bracket is connected to the vehicle.

4. The apparatus recited in claim 2, wherein said deployment portion defines a concave channel for receiving said inflatable curtain in a deflated and stored condition.

5. The apparatus recited in claim 2, wherein said deployment portion extends away from the side structure and inboard in the vehicle.

6. The apparatus recited in claim 1, wherein said bracket further comprises a connecting portion for receiving fastening means for connecting said bracket assembly, the fill tube, and the inflatable curtain to the vehicle.

7. The apparatus recited in claim 6, wherein said bracket has a length, said deployment portion extending substantially along the length of said bracket, said support portion comprising a plurality of supports spaced along the length of said bracket, said connecting portion comprising a plurality of flanges spaced along the length of said bracket.

8. The apparatus recited in claim 6, wherein said connecting portion comprises a hook portion insertable into an opening in the vehicle to initially support said bracket assembly, the fill tube, and the inflatable curtain in the vehicle prior to said fastening means connecting said bracket assembly, the fill tube, and the inflatable curtain to the vehicle.

9. The apparatus recited in claim 8, wherein said hook comprises a barb portion that is adapted to engage vehicle sheet metal adjacent the opening into which said hook portion is insertable to help prevent removal of said hook member from said opening.

10. The apparatus recited in claim 1, wherein said support portion at least partially encircles a portion of said fill tube to help connect said bracket to said fill tube.

11. The apparatus recited in claim 1, wherein said support portion has an inner surface with a cylindrical portion that mates with a cylindrical outer surface of said fill tube.

12. The apparatus recited in claim 1, wherein said fill tube support portion includes an opening through which said interlocking portion of said retainer extends to help connect said retainer to said support portion.

13. The apparatus recited in claim 1, wherein said interlocking portion comprises a hook portion extendable through an opening in said support portion and hooks onto a bar portion of said support portion, said bar portion being partially defined by said opening.

14. The apparatus recited in claim 1, wherein said support portion is extendable through a sealed opening extending through the inflatable curtain.

15. The apparatus recited in claim 1, wherein said support portion receives a portion of the inflatable curtain, said support portion in combination with said retainer connecting the inflatable curtain to said bracket.

16. The apparatus recited in claim 1, wherein said retainer comprises a connector portion and a retainer portion that extend transverse to each other, said cooperating portion of said retainer being located along a terminal edge portion of said retainer portion, said tabs extending through said connector portion.

17. The apparatus recited in claim 16, wherein said support portion and said retainer portion in combination encircle the portion of the fill tube to connect the fill tube to the bracket.

18. The apparatus recited in claim 1, wherein said at least one tab comprises a pair of tabs extendable through respective openings in said retainer.

19. The apparatus recited in claim 1, wherein said bracket and said retainer are separate pieces.

20. An apparatus for supporting an inflatable curtain and a fill tube in a vehicle, said apparatus comprising:
a bracket including a support portion for receiving a portion of the fill tube; and
a retainer connectable to said bracket to retain the fill tube in said support portion, said retainer including a hook portion for hooking onto said support portion to help connect said retainer to said bracket;
said bracket including at least one tab extendable through openings in said retainer and deformable against said retainer to help connect said retainer to said bracket, said retainer and said support portion connecting the fill tube to said bracket.

21. An apparatus for helping to protect an occupant of a vehicle that has a roof and a side structure, said apparatus comprising:
an inflatable curtain that is inflatable away from the vehicle roof to a position adjacent the side structure of the vehicle;
a fill tube for directing inflation fluid from an inflation fluid source into said inflatable curtain;
a bracket including a support portion for receiving a portion of the fill tube; and
a retainer connectable to said bracket to retain the fill tube in said support portion, said retainer having a portion that interlocks with said support portion to help connect said retainer to said bracket;
said bracket including at least one tab extendable through said retainer and deformable against said retainer to help connect said retainer to said bracket, said retainer and said support portion in combination encircling the portion of the fill tube to connect the fill tube to said bracket.

22. A bracket assembly for supporting an inflatable curtain and a fill tube in a vehicle, said bracket assembly comprising:
a support portion for receiving a portion of the fill tube and connecting the fill tube to said bracket assembly;
a connecting portion for receiving fastening means for connecting said bracket assembly fixedly to the vehicle; and
a hook portion insertable into an opening in the vehicle to initially support said bracket assembly, the fill tube, and the inflatable curtain in the vehicle, said hook portion comprising a barb portion for engaging vehicle sheet metal adjacent the opening into which said hook portion is insertable to help prevent removal of said hook portion from said opening.
